(19) United States
(12) Patent Application Publication
(10) Pub. No.: US 2022/0129802 A1
(43) Pub. Date: Apr. 28, 2022

(54) COMPUTER SYSTEM AND PLAN EVALUATION METHOD

(71) Applicant: Hitachi, Ltd., Tokyo (JP)

(72) Inventors: Yuya OKADOME, Tokyo (JP); Toshiko AIZONO, Tokyo (JP)

(21) Appl. No.: 17/469,973

(22) Filed: Sep. 9, 2021

(30) Foreign Application Priority Data
Oct. 22, 2020 (JP) 2020-177111

(51) Int. Cl. G06Q 10/06

(52) U.S. Cl. CPC G06Q 10/0633

(57) ABSTRACT

A computer system is coupled to a first database and a second database, the first database storing model information defining a model, the second database storing history data indicating a plan developed in a past. The computer system generates, in a case of receiving an evaluation query including evaluation plan data that indicates an evaluation target plan, a plurality of pieces of the pair data each of which is a pair of the evaluation plan data and the history data; obtains a plurality of prediction results by inputting the plurality of pieces of the pair data to the model; select a piece of the history data that has an evaluation index small in difference from the evaluation index of the evaluation target plan based on the plurality of prediction results; and output the selected piece of the history data.

### CLAIM OF PRIORITY

The present application claims priority from Japanese patent application JP 2020-177111 filed on Oct. 22, 2020, the content of which is hereby incorporated by reference into this application.

### BACKGROUND OF THE INVENTION

This invention relates to a technology of evaluating a developed plan.

In recent years, a system for automatically developing plans for conveyance work in a warehouse, recovery work to recover from an accident, reconstruction tasks in a disaster-affected area, and the like is being introduced. For instance, a technology described in WO 2018/220885 has been known.

In WO 2018/220885, there is included a description “A planning module calculates a plan pattern including order of producing products, based on history information about production plans that have been developed in the past to produce the products, in consideration of constraint conditions under which the products are produced, and rearranges the order of producing the products following the calculated plan pattern, to thereby generate a plurality of plan candidates for a production plan of the products. A plan evaluation module evaluates the plurality of production candidates based on evaluation indices for the restraint conditions, and selects the best production plan out of the plurality of plan candidates.”

### SUMMARY OF THE INVENTION

In the related art, a plan is quantitatively evaluated with the use of an evaluation index. To calculate the evaluation index, however, a relationship between an attribute included in the plan and the evaluation index is required to be analyzed. The evaluation index cannot be calculated in a case where the relationship is unknown. In addition, in a case where an evaluation index dependent on a specific condition is used, a plan having a different condition cannot correctly be evaluated.

An object of this invention is to achieve a system and a method with which information for evaluating a plan to be evaluated is provided.

A representative example of the present invention disclosed in this specification is as follows: a computer system comprises at least one computer including an arithmetic apparatus, a storage apparatus, and a coupling interface. The computer system is coupled to a first database and a second database, the first database storing model information defining a model which receives, as input, pair data that is a combination of two pieces of plan data each indicating a plan developed in order to achieve a predetermined goal, and which outputs a prediction result indicating a magnitude relationship between evaluation indices of the two plans, the second database storing history data indicating a plan developed in a past. The history data includes a value of an attribute related to the plan. The at least one computer is configured to: generate, in a case where an evaluation query including evaluation plan data that indicates an evaluation target plan has been received, a plurality of pieces of the pair data each of which is a pair of the evaluation plan data and the history data; obtain a plurality of prediction results by inputting the plurality of pieces of the pair data to the model; select a piece of the history data that has an evaluation index small in difference from the evaluation index of the evaluation target plan based on the plurality of prediction results; and output plan evaluation information including the selected piece of the history data.

According to at least one embodiment of this invention, the computer system can provide information for evaluating a plan to be evaluated. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram for illustrating a configuration example of a computer system according to a first embodiment of this invention;

FIG. 2 is a diagram for illustrating an image of operation of the computer system according to the first embodiment;

FIG. 3 is a flow chart for illustrating outline of the processing executed by a learning module in the first embodiment;

FIG. 4 is a flow chart for illustrating pair data generation processing executed by the learning module in the first embodiment;

FIG. 5 is a flow chart for illustrating model learning processing executed by the learning module in the first embodiment;

FIG. 6 is a flow chart for illustrating the processing executed by a plan evaluation module in the first embodiment;

FIG. 7 is a diagram for illustrating an image of operation of the computer system according to a second embodiment;

FIG. 8 is a table for showing an example of warehouse management information in the second embodiment;

FIG. 9 is a table for showing an example of warehouse control information in the second embodiment;

FIG. 10 is a table for showing an example of resource data in the second embodiment;

FIG. 11 is a table for showing an example of work contents data in the second embodiment;

FIG. 12 is a diagram for illustrating an example of a screen to be displayed on a terminal in the second embodiment.

FIG. 13 is a diagram for illustrating an image of operation of the computer system according to a third embodiment;

FIG. 14 is a table for showing an example of train operation record information in the third embodiment;

FIG. 15 is a table for showing an example of route/station information in the third embodiment;

FIG. 16 is a table for showing an example of accident information in the third embodiment;

FIG. 17 is a table for showing an example of accident data in the third embodiment;

FIG. 18 is a table for showing an example of recovery work contents data in the third embodiment;

FIG. 19 is a diagram for illustrating an example of the screen to be displayed on the terminal in the third embodiment.

FIG. 20 is a diagram for illustrating an image of operation of the computer system according to a fourth embodiment;

FIG. 21 is a table for showing an example of past disaster information in the fourth embodiment;

FIG. 22 is a table for showing an example of city information in the fourth embodiment;

FIG. 23 is a table for showing an example of rescue manpower planning information in the fourth embodiment;

FIG. 24 is a table for showing an example of disaster data in the fourth embodiment;

FIG. 25 is a table for showing an example of rescue personnel data in the fourth embodiment;

FIG. 26 is a diagram for illustrating an example of the screen to be displayed on the terminal in the fourth embodiment.

FIG. 27 is a diagram for illustrating an image of operation of the computer system according to a fifth embodiment; and

FIG. 28 is a flow chart for illustrating processing executed by the plan evaluation module in the fifth embodiment.

### DETAILED DESCRIPTION OF THE PREFERRED EMBODIMENTS

Now, a description is given of an embodiment of this invention referring to the drawings. It should be noted that this invention is not to be construed by limiting the invention to the content described in the following embodiment. A person skilled in the art would easily recognize that a specific configuration described in the following embodiment may be changed within the scope of the concept and the gist of this invention.

In a configuration of this invention described below, the same or similar components or functions are assigned with the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and other metrics in order to facilitate understanding of this invention. Thus, this invention is not limited to the position, size, shape, range, and others described in, for example, the drawings.

### First Embodiment

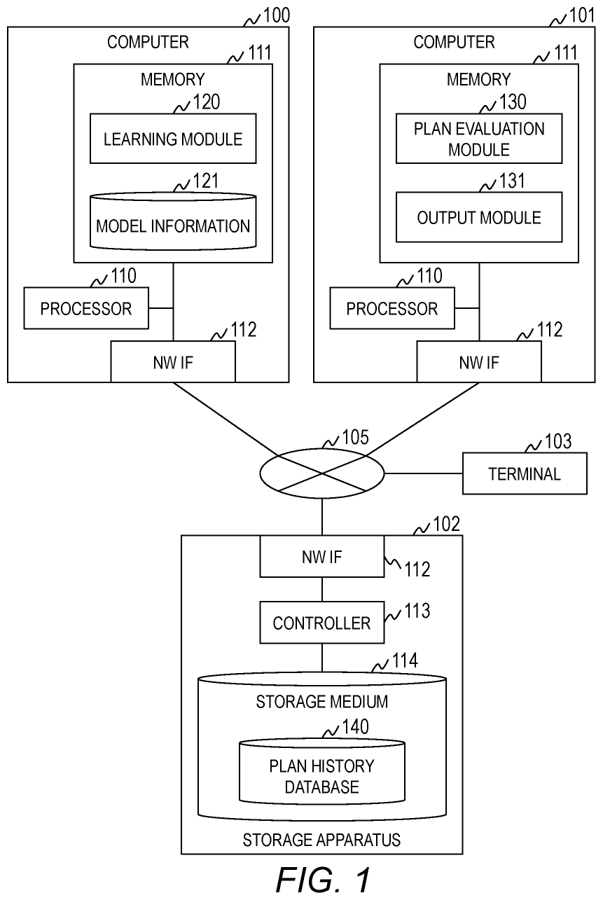

FIG. 1 is a diagram for illustrating a configuration example of a computer system according to a first embodiment of this invention.

The computer system includes computers 100 and 101, a storage apparatus 102, and a terminal 103, and provides information for evaluating a plan developed to achieve a predetermined goal. The computers 100 and 101, the storage apparatus 102, and the terminal 103 are coupled to one another via a network 105. The network 105 is, for example, a wide area network (WAN) or a local area network (LAN). Wired coupling and wireless coupling are both coupling methods usable for the network 105.

Examples of a plan to be developed include a plan for warehouse work, a plan for recovery from a railroad accident, and a reconstruction plan of a disaster-affected area. This invention is not limited by the type and contents of a plan.

The computer 100 executes machine learning for generating a model described later. The computer 100 includes a processor 110, a memory 111, and a network interface 112.

The computer 100 may include a hard disk drive (HDD), a solid-state drive (SSD), or a similar storage medium. The computer 100 may also include a keyboard, a mouse, a touch panel, or a similar input device, as well as an output device that is a display or the like.

The processor 110 executes a program stored in the memory 111. The processor 110 operates as a module for implementing a specific function by executing processing as programmed by the program. In the following description, a sentence describing processing with a module as the subject of the sentence means that a program for implementing the module is executed by the processor 110.

The memory 111 stores programs to be executed by the processor 110 and information to be used by the program. The memory 111 is also used as a work area. The memory 111 stores a program for implementing a learning module 120 and model information 121.

The model information 121 is definition information of a model described later. When the model is a neural network, parameters defining a structure and the like of the neural network are stored as the model information 121.

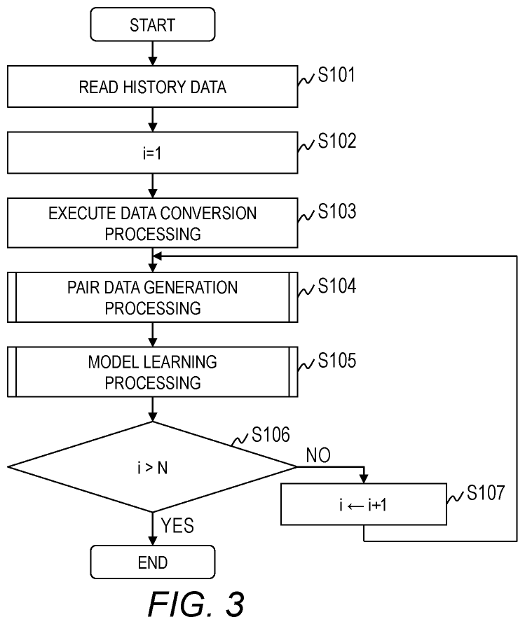

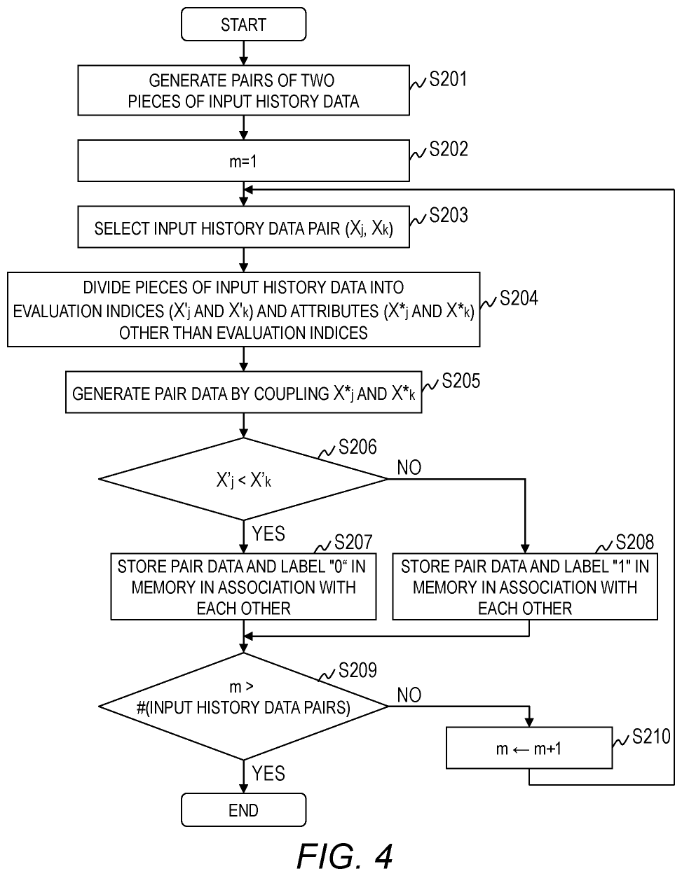

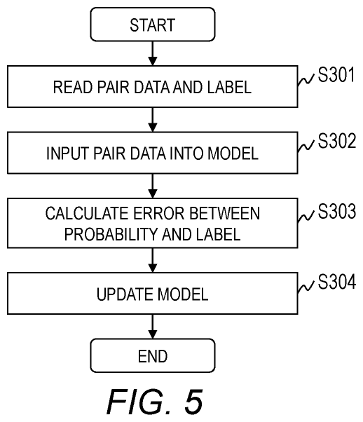

The learning module 120 executes learning for generating or updating the model. Details of processing executed by the learning module 120 are described with reference to FIG. 3, FIG. 4, and FIG. 5.

The storage apparatus 102 manages plans developed in the past (a plan history). The storage apparatus 102 includes a controller 113, a network interface 112, and a storage medium 114.

The controller 113 includes a processor, a memory, a disk interface, and others (not shown). The controller 113 handles overall control of the storage apparatus 102.

The storage medium 114 is an HDD, an SSD, or the like, and permanently stores data. The storage apparatus 102 may include more than one storage medium 114. In this case, the more than one storage medium 114 may be used to form redundant arrays of inexpensive disks (RAID).

The storage medium 114 stores a plan history database 140. The plan history database 140 is a database for storing history data indicating a history of plans developed in the past. The plan history database 140 stores, in addition to the history data including attributes that indicate contents of a plan history and attributes that indicate evaluation indices, data related to the plans. For example, data indicating an environment is stored.

The evaluation indices are only required to be managed in association with the history data, and the history data may not include attributes that indicate the evaluation indices.

The evaluation indices are each set based on an actual action result based on a plan.

The computer 101 outputs information for evaluating, with the use of a model, a plan to be evaluated. The computer 101 has a hardware configuration that is the same as the hardware configuration of the computer 100.

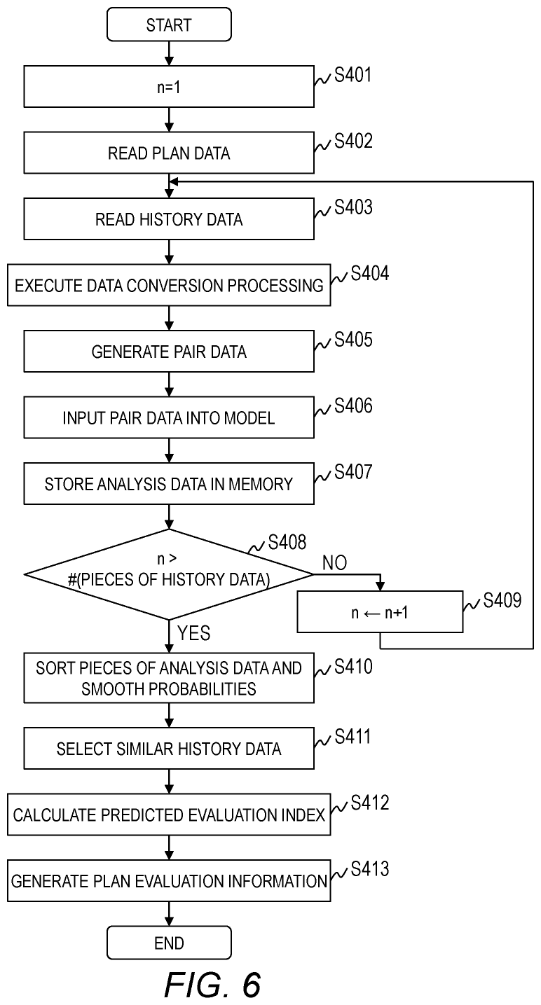

The memory 111 of the computer 101 stores programs for implementing a plan evaluation module 130 and an output module 131. The plan evaluation module 130 generates information for evaluating a plan to be evaluated. Details of processing executed by the plan evaluation module 130 are described with reference to FIG. 6. The output module 131 outputs the information generated by the plan evaluation module 130 to the terminal 103 or others.

The terminal 103 is a computer, a smartphone, or the like that is operated by a user. The terminal 103 includes a processor, a memory, a network interface, an input device, and an output device (not shown).

The configuration of the computer system illustrated in FIG. 1 is an example, and this invention is not limited thereto. For example, the learning module 120, the plan evaluation module 130, and the output module 131 may operate on one computer. The computer system may also be configured so that one of the computers 100 and 101 holds the plan history database 140.

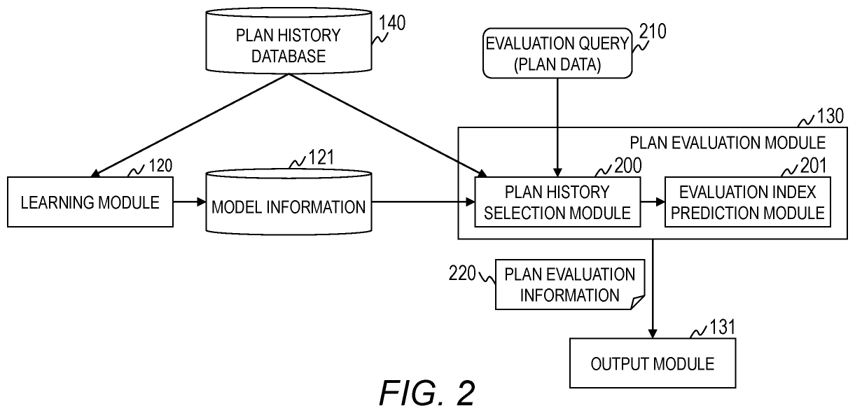

FIG. 2 is a diagram for illustrating an image of operation of the computer system according to the first embodiment.

The learning module 120 generates the model information 121 with the use of the history data stored in the plan history database 140. The model in the first embodiment receives input of two plans, and outputs a probability at which an evaluation index of one of the two plans is lower than an evaluation index of another of the two plans.

The user uses the terminal 103 to transmit an evaluation query 210 including plan data that indicates a plan to be evaluated to the plan evaluation module 130.

In a case of receiving the evaluation query 210, the plan evaluation module 130 calls a plan history selection module 200.

The plan history selection module 200 uses the model information 121, the plan data, and the history data to select a piece of history data of the plan history that is close to the evaluation index of the plan to be evaluated, and outputs a notification of completion of the processing to the plan evaluation module 130. The plan evaluation module 130 calls an evaluation index prediction module 201, and inputs the selected piece of history data.

The evaluation index prediction module 201 uses the selected piece of history data to predict the evaluation index of the plan to be evaluated.

The plan evaluation module 130 generates plan evaluation information 220 including processing results, and outputs the plan evaluation information 220 to the output module 131. The plan evaluation information 220 includes at least one of the selected piece of history data and a predicted value of the evaluation index.

The output module 131 outputs information for displaying a screen on the terminal 103, based on the plan evaluation information 220.

FIG. 3 is a flow chart for illustrating outline of the processing executed by the learning module 120 in the first embodiment.

The learning module 120 starts processing described below in a case of receiving an execution instruction, or in a case where the plan history database 140 is set or updated.

The learning module 120 reads a plurality of pieces of history data out of the plan history database 140, and stores the read pieces of history data in the memory 111 (Step S101).

The learning module 120 next sets an initial value “1” to a variable i (Step S102). The variable i is a variable representing an epoch.

The learning module 120 next executes data conversion processing for converting the history data into data having a format that allows the data to be input to the model (Step S103).

For example, the learning module 120 extracts a value of an attribute to be used from the history data, and executes regularization, normalization, and the like. This invention is not limited by the contents of the data conversion processing.

In the following description, the history data for which the data conversion processing has been executed is referred to as “input history data.”

The learning module 120 next executes pair data generation processing for generating pair data in which two pieces of input history data form one pair (Step S104). Details of the pair data generation processing are described with reference to FIG. 4.

The learning module 120 next executes model learning processing using the pair data (Step S105). Details of the model learning processing are described with reference to FIG. 5.

The learning module 120 next determines whether a value of the variable i is larger than a threshold value N (Step S106). The threshold value N is set in advance.

In a case where the value of the variable i is equal to or less than the threshold value N, the learning module 120 adds 1 to the value of the variable i (Step S107), and then returns to Step S104.

In a case where the value of the variable i is more than the threshold value N, the learning module 120 ends the processing.

FIG. 4 is a flow chart for illustrating the pair data generation processing executed by the learning module 120 in the first embodiment.

The learning module 120 uses a plurality of pieces of input history data to generate a plurality of pairs each of which is formed from two pieces of input history data (Step S201). Pairing of pieces of input history data is executed through random selection. The number of input history data pairs is set in advance.

The learning module 120 next sets the initial value “1” to a variable m (Step S202). The variable m is a variable indicating the number of input history data pairs that have been processed.

The learning module 120 next selects one input history data pair (Step S203). Here, a pair formed from input history data Xⱼ and input history data Xₖ is selected.

The learning module 120 next divides attributes included in the input history data Xⱼ and input history data Xₖ into evaluation indices and attributes other than evaluation indices (Step S204). Here, the evaluation indices are denoted by X′ⱼ and X′ₖ, and attributes other than evaluation indices are denoted by X*ⱼ and X*ₖ. The evaluation indices X′ⱼ and X′ₖ are scalars, and the attributes X*ⱼ and X*ₖ are vectors.

The learning module 120 next generates pair data by coupling the attributes X*ⱼ and X*ₖ (Step S205).

The learning module 120 next determines whether the evaluation index X′ⱼ is smaller than the evaluation index X′ₖ (Step S206).

In a case where the evaluation index X′ⱼ is smaller than the evaluation index X′ₖ, the learning module 120 stores the pair data in the memory 111 in association with a label “0” (Step S207). The learning module 120 then proceeds to Step S209.

In a case where the evaluation index X′ⱼ is equal to or larger than the evaluation index X′ₖ, the learning module 120 stores the pair data in the memory 111 in association with a label “1” (Step S208). The learning module 120 then proceeds to Step S209.

In Step S209, the learning module 120 determines whether the variable m is larger than the number of input history data pairs (Step S209).

In a case where the variable m is equal to or smaller than the number of input history data pairs, the learning module 120 adds 1 to a value of the variable m (Step S210), and then returns to Step S203.

In a case where the variable m is larger than the number of input history data pairs, the learning module 120 ends the pair data generation processing.

Normally, a day-to-day plan or an accident-by-accident basis plan is generated, and a required number of pieces of data for machine learning is accordingly not reached in many cases, resulting in a failure to generate a model or a model low in precision. This invention therefore increases the number of pieces of learning data by generating pairs of pieces of history data as learning data.

After Step S205, the learning module 120 may determine whether an absolute value of a difference between the evaluation indices of the pieces of history data forming the pair data is smaller than a threshold value to skip Step S206, Step S207, and Step S208 in a case where the absolute value of the difference between the evaluation indices of the pieces of data forming the pair data is smaller than the threshold value.

FIG. 5 is a flow chart for illustrating the model learning processing executed by the learning module 120 in the first embodiment.

The learning module 120 reads pair data and a label out of the memory 111 (Step S301).

The learning module 120 next inputs the pair data to a model defined by the model information 121 (Step S302). The model outputs a probability of the evaluation index of one plan history being smaller than the evaluation index of another of the plan history. Here, a probability of the evaluation index X′ⱼ being smaller than the evaluation index X′ₖ is output. The probability output from the model indicates a relative magnitude relationship between the evaluation indices.

The learning module 120 next calculates an error between the probability output from the model and the label (Step S303), and updates the model based on an optimization algorithm for decreasing the error (Step S304). The learning module 120 then ends the model learning processing. A result of updating the model is reflected in the model information 121.

The optimization algorithm is, for example, stochastic gradient descent or Adam. This invention is not limited by the type of the optimization algorithm.

The model generated by the learning module 120 is a model with which a magnitude relationship between evaluation indices of plans generated under different conditions can be predicted.

FIG. 6 is a flow chart for illustrating the processing executed by the plan evaluation module 130 in the first embodiment.

The plan evaluation module 130 receives the evaluation query 210, and then starts processing described below.

The plan evaluation module 130 sets an initial value “1” to a variable n (Step S401). The variable n is a variable indicating the number of plan history (the number of pieces of history data) that have been processed.

The plan evaluation module 130 next reads plan data included in the evaluation query 210 (Step S402).

The plan evaluation module 130 next reads one unprocessed piece of history data out of the plan history database 140 (Step S403).

The plan evaluation module 130 next executes data conversion processing for the plan data and the history data (Step S404).

The plan evaluation module 130 next generates pair data by coupling the plan data and the history data for which the data conversion processing has been executed (Step S405). The same method as the one in Step S204 and Step S205 is employed as a method of generating the pair data.

The plan history selection module 200 of the plan evaluation module 130 next inputs the pair data to a model defined by the model information 121 (Step S406). The model outputs a probability of an evaluation index of the plan data being smaller than an evaluation index of the history data.

The evaluation index of the plan data is unknown, but a relative magnitude relationship between the evaluation index of the plan data and the evaluation index of the history data can be estimated with the use of the model.

Next, the plan history selection module 200 of the plan evaluation module 130 stores, in the memory 111, analysis data including identification information of the history data and including the probability (Step S407).

The plan history selection module 200 of the plan evaluation module 130 next determines whether a value of the variable n is larger than the number of pieces of history data (Step S408).

In a case where the value of the variable n is equal to or smaller than the number of pieces of history data, the plan history selection module 200 of the plan evaluation module 130 adds 1 to the value of the variable n (Step S409), and then returns to Step S403.

In a case where the value of the variable n is larger than the number of pieces of history data, the plan history selection module 200 of the plan evaluation module 130 sorts pieces of analysis data based on the magnitudes of evaluation indices of pieces of history data each forming a piece of pair data, and further smooths probabilities of the pieces of analysis data (Step S410).

Specifically, the plan history selection module 200 sorts the pieces of analysis data in ascending order of the evaluation indices of the pieces of history data, and assigns a numerical value indicating a place in the sorted order to each of the pieces of analysis data. Here, the numerical values are assigned in order starting from 1. A known method can be used to smooth the probabilities, and a detailed description of the smoothing is therefore omitted. The smoothing of the probabilities may be executed in a case where an instruction from a user is received.

The plan history selection module 200 of the plan evaluation module 130 next selects similar history data based on the probabilities (Step S411).

Specifically, the plan history selection module 200 selects the analysis data in which an error between the probability and 0.5 is smaller than a threshold value. The value “0.5” represents a boundary at which the magnitude relationship between evaluation indices of two plans is reversed. That is, being close to 0.5 means that an error between the evaluation indices of the two plans is small.

Next, the evaluation index prediction module 201 of the plan evaluation module 130 calculates a predicted evaluation index of the plan data based on an evaluation index of the similar history data (Step S412). Examples of a possible method of the calculation are given below.

(1) In a case where there is one piece of similar history data, the evaluation index prediction module 201 calculates the evaluation index of the similar history data as the predicted evaluation index without modification.

(2) In a case where there is one piece of similar history data, the evaluation index prediction module 201 identifies pieces of analysis data preceding and following, in analysis data sorting number, a piece of analysis data that corresponds to the similar history data, and obtains evaluation indices of pieces of history data that correspond to the identified pieces of analysis data. The evaluation index prediction module 201 calculates an average value of the evaluation index of the similar history data and the obtained evaluation indices as the predicted evaluation index.

(3) In a case where there are a plurality of pieces of similar history data, the evaluation index prediction module 201 calculates an average value of evaluation indices of the plurality of pieces of similar history data as the predicted evaluation index.

Next, the plan evaluation module 130 generates the plan evaluation information 220 (Step S413), and then ends the processing.

For example, the plan evaluation module 130 generates the plan evaluation information 220 that includes at least one of the similar history data and the predicted evaluation index. The plan evaluation module 130 may include a result of sorting the pieces of analysis data in the plan evaluation information 220. The plan evaluation module 130 stores the plan evaluation information 220 in the memory 111 in association with identification information of the evaluation query 210.

The plan evaluation module 130 may omit Step S412. In this case, the plan evaluation information 220 includes the similar history data.

According to the first embodiment, the computer system can present one of the similar history data and the predicted evaluation index as information for evaluating a plan input to the computer system. Reference to the similar history data enables the user to evaluate whether the plan is good, and execute verification of the plan as well. The user can quantitatively evaluate the plan based on the predicted evaluation index.

From a second embodiment of this invention to a fourth embodiment of this invention, specific methods for application of the computer system described in the first embodiment are described.

### Second Embodiment

In the second embodiment, a computer system for outputting a predicted work time of a warehouse work plan is described.

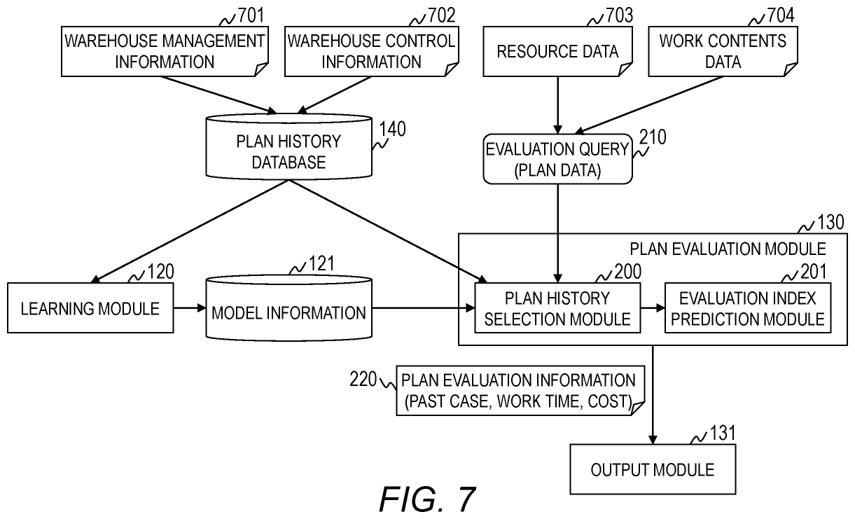

A configuration of the computer system according to the second embodiment is the same as the computer system configuration in the first embodiment, and a description thereof is therefore omitted. FIG. 7 is a diagram for illustrating an image of operation of the computer system according to the second embodiment.

The plan history database 140 stores warehouse management information 701 obtained from a warehouse management system (WMS) and warehouse control information 702 obtained from a warehouse control system (WCS).

The terminal 103 transmits the evaluation query 210 including plan data that includes resource data 703 and work contents data 704 to the plan evaluation module 130.

The plan evaluation module 130 generates the plan evaluation information 220 including the similar history data (a past case) and including a work time and a cost, and outputs the plan evaluation information 220 to the output module 131. The work time and the cost are the predicted evaluation index.

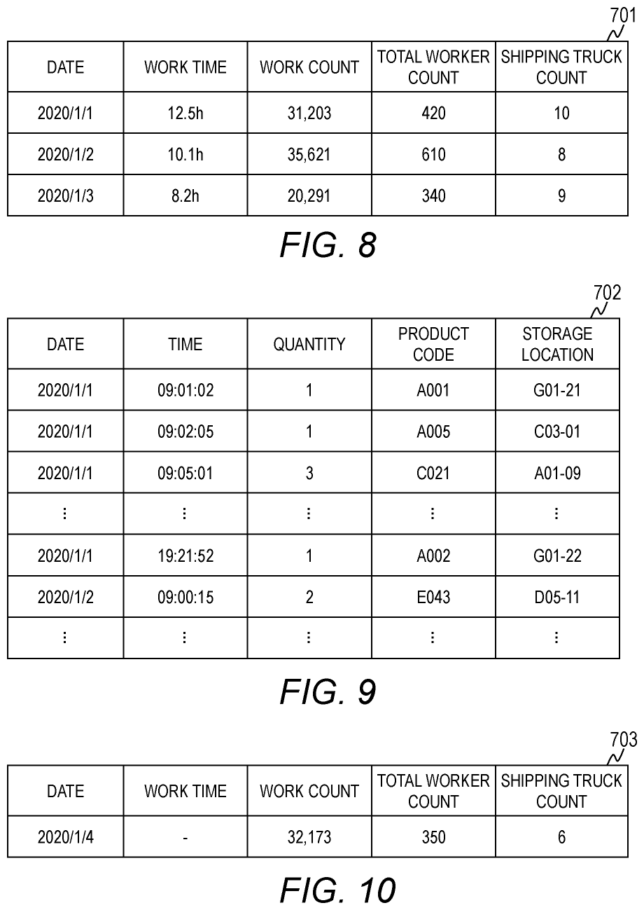

FIG. 8 is a table for showing an example of the warehouse management information 701 in the second embodiment.

The warehouse management information 701 is information about allocation of resources (manpower and equipment) of warehouse work. The warehouse management information 701 holds a record including “date,” “work time,” “work count,” “total worker count,” and “shipping truck count.” The warehouse management information 701 has one record for one day as a day-to-day record.

FIG. 9 is a table for showing an example of the warehouse control information 702 in the second embodiment.

The warehouse control information 702 is information about specific contents of warehouse work. The warehouse control information 702 holds a record including “date,” “time,” “quantity,” “product code,” and “storage location.” The warehouse control information 702 has one record for one piece of work.

Records holding the same date form work contents of one day. The records are managed in association with a record of the warehouse management information 701 in which “date” is the same as the date held by the records.

FIG. 10 is a table for showing an example of the resource data 703 in the second embodiment.

The resource data 703 is data about allocation of resources in warehouse work. The resource data 703 includes “date,” “work time,” “work count,” “total worker count,” and “shipping truck count.”

After warehouse work is executed, a record is registered in the warehouse management information 701 based on the resource data 703.

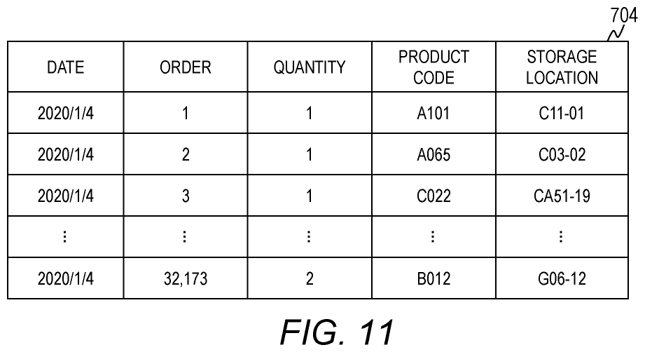

FIG. 11 is a table for showing an example of the work contents data 704 in the second embodiment.

The work contents data 704 is information about specific contents of warehouse work. The work contents data 704 holds a record including “date,” “order,” “quantity,” “product code,” and “storage location.” The work contents data 704 has one record for one piece of work.

After warehouse work is executed, a record is registered in the warehouse control information 702 based on the work contents data 704.

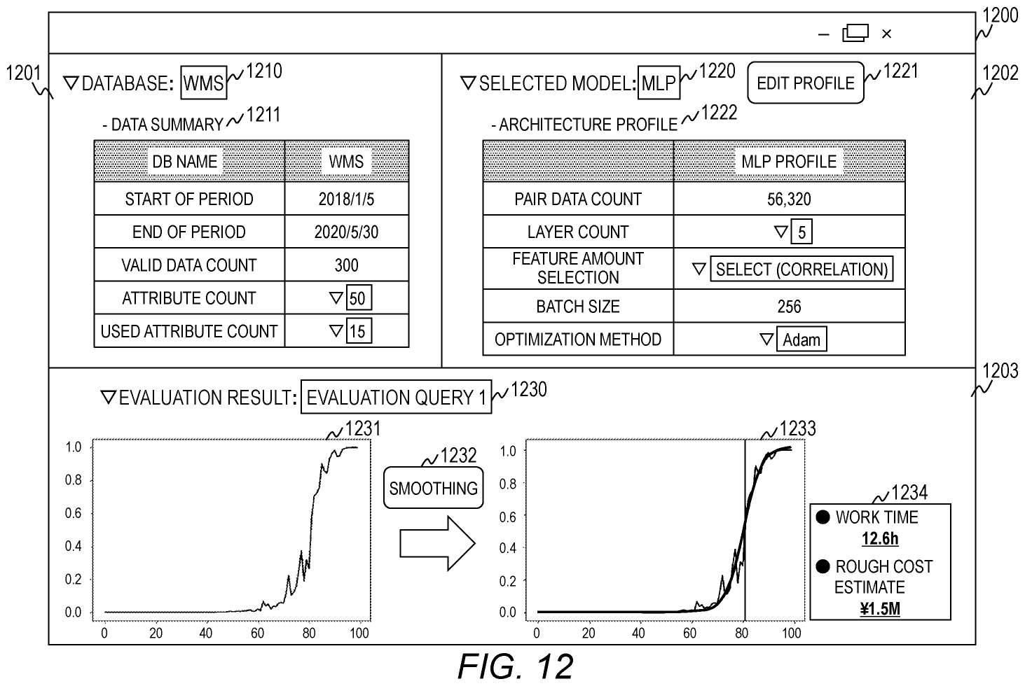

FIG. 12 is a diagram for illustrating an example of a screen 1200 to be displayed on the terminal 103 in the second embodiment.

The screen 1200 is a screen displayed based on the plan evaluation information 220, and includes a data setting field 1201, a learning setting field 1202, and an evaluation result field 1203. The fields may be displayed as separate screens.

The data setting field 1201 is a field for setting settings about history data to be used to generate a model. The data setting filed 1201 includes a database selection field 1210 and a database summary field 1211.

The database selection field 1210 is a field for selecting a source from which the history data to be used to generate a model is obtained. A system name, an information name, or the like is input to the database selection field 1210. In FIG. 12, a warehouse management system is selected. Accordingly, in the second embodiment, records of the warehouse management information 701 are treated as history data. In this case, the plan evaluation module 130 extracts attributes of the resource data 703 from the plan data in the data conversion processing of Step S404. In Step S405, the plan evaluation module 130 generates pair data with the use of the attributes of the resource data 703 and attributes of the history data.

The database summary field 1211 is a field for displaying a summary of the plan history database 140. The database summary field 1211 includes “start of period,” “end of period,” “valid data count,” “attribute count,” and “used attribute count.” Those are an example, and items displayed in the database summary field 1211 are not limited thereto.

“Start of period” and “end of period” indicate a period in which history data has been obtained. “Valid data count” indicates the number of pieces of history data that are usable. “Attribute count” indicates the number of attributes included in the history data. A value of “attribute count” is adjustable by a user. “Used attribute count” indicates the number of attributes to be used in learning. A value of “used attribute count” is adjustable by the user.

The learning setting field 1202 is a field for setting a learning method and a structure of a model. The learning setting field 1202 includes a model selection field 1220, a profile edit button 1221, and a profile edit field 1222.

The model selection field 1220 is a field for selecting a model type. In FIG. 12, Multilayer Perceptron (MLP) is selected.

The profile edit button 1221 is a button for editing parameters of the model, a feature amount employed in the model, and the like. In a case where the profile edit button 1221 is operated, input to the profile edit field 1222 is enabled.

The profile edit field 1222 includes “pair data count,” “layer count,” “feature amount selection,” “batch size,” and “optimization method.” Those are an example, and items displayed in the profile edit field 1222 are not limited thereto.

“Pair data count” indicates the number of pieces of pair data generated by the pair data generation processing. “Layer count” indicates the number of layers of MLP. “Feature amount selection” indicates, for example, a method of selecting a feature amount to be used in learning. The user can select any selection method. In FIG. 12, “select (correlation)” meaning that one feature amount out of correlated feature amounts is to be used is selected. “Batch size” indicates a batch size in learning. “Optimization method” indicates a method of optimizing the model. The user can select any optimization method. In FIG. 12, Adam is selected.

The evaluation result field 1203 is a field for displaying similar history data and others included in the plan evaluation information 220. The evaluation result field 1203 includes an evaluation result selection field 1230, a graph display field 1231, a smoothing button 1232, a graph display field 1233, and an evaluation result display field 1234. Those are an example, and items displayed in the evaluation result field 1203 are not limited thereto.

The evaluation result selection field 1230 is a field for selecting a piece of the plan evaluation information 220 to be displayed. The plan evaluation information 220 is managed in association with the identification information of the evaluation query 210.

The graph display field 1231 is a field for displaying a graph that indicates results of sorting pieces of analysis data. An axis of abscissa indicates a sort number, and an axis of ordinate indicates a probability.

The smoothing button 1232 is an operation button for issuing an instruction to smooth the graph.

The graph display field 1233 is a field for displaying the graph that has been smoothed. A bold line graph represents the smoothed graph. The graph display field 1233 also displays a straight line indicating the sort number of a piece of history data that has a probability closest to 0.5.

The evaluation result display field 1234 is a field for displaying values included in the plan evaluation information 220. In the second embodiment, work time and a rough cost estimate that are a predicted evaluation index are displayed in the evaluation result display field 1234.

The computer system according to the second embodiment can select the similar history data based on the plan data, and further present a work time and a rough cost estimate with the use of the similar history data. The user can evaluate whether a work plan is good and determine contents of correction and the like based on the similar history data, the work time, and the rough cost estimate. For example, the user can correct the number of workers to be distributed and work contents by referring to a record of the warehouse management information 701 that is selected as the similar history data and a record of the warehouse control information 702 that is associated with the selected record.

### Third Embodiment

In the third embodiment, a computer system for outputting information about a similar railroad accident from a plan for recovery from a railroad accident is described.

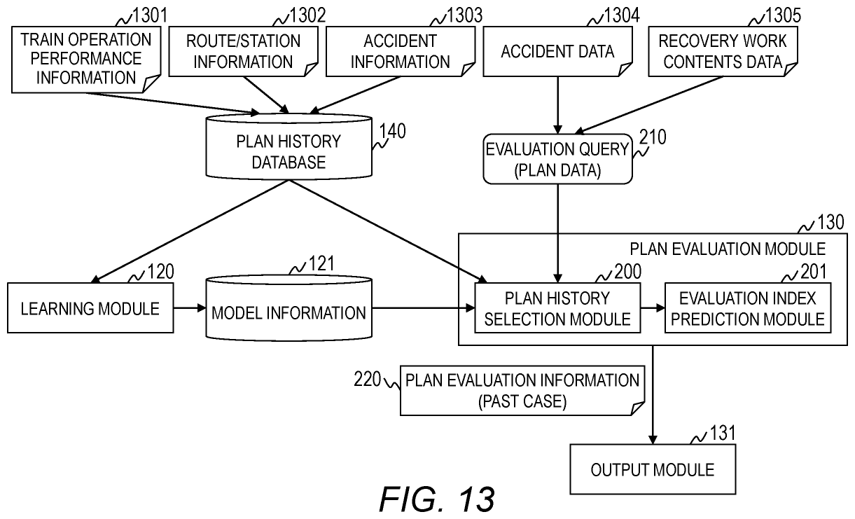

A configuration of the computer system according to the third embodiment is the same as the computer system configuration in the first embodiment, and a description thereof is therefore omitted. FIG. 13 is a diagram for illustrating an image of operation of the computer system according to the third embodiment.

The plan history database 140 stores train operation record information 1301, route/station information 1302, and accident information 1303, which are obtained from a system run by a railroad company.

The terminal 103 transmits the evaluation query 210 including plan data that includes accident data 1304 and recovery work contents data 1305 to the plan evaluation module 130.

The plan evaluation module 130 generates the plan evaluation information 220 including the similar history data (a past case), and outputs the plan evaluation information 220 to the output module 131.

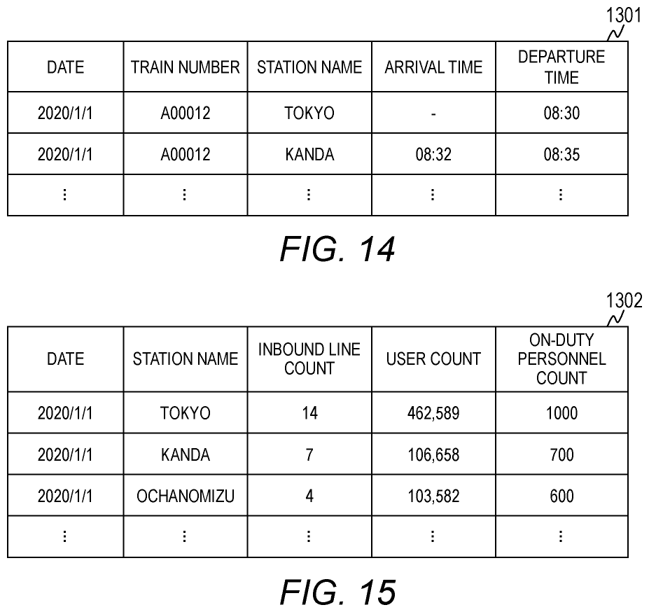

FIG. 14 is a table for showing an example of the train operation record information 1301 in the third embodiment.

The train operation record information 1301 is information for managing railroad operation record. The train operation record information 1301 holds a record including “date,” “train number,” “station name,” “arrival time,” and “departure time.” The train operation record information 1301 has one record for one running of a train (running from a departure station to an arrival station).

A record in which “departure time” has no value indicates operation record of a first train in the morning.

FIG. 15 is a table for showing an example of the route/station information 1302 in the third embodiment.

The route/station information 1302 is information for managing inbound lines of a station and the like. The route/station information 1302 holds a record including “date,” “station name,” “inbound line count,” “user count,” and “on-duty personnel count.” The route/station information 1302 has one record for one combination of “date” and “station name.”

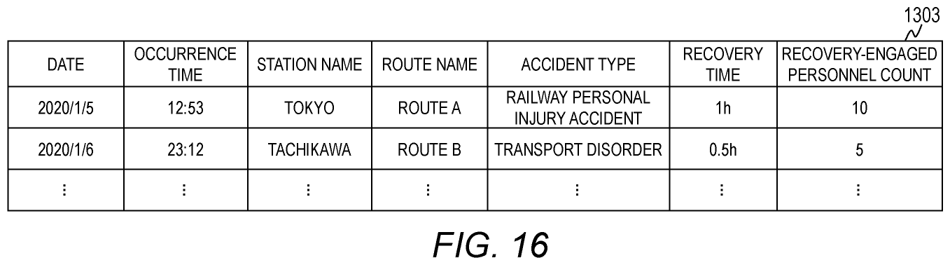

FIG. 16 is a table for showing an example of the accident information 1303 in the third embodiment.

The accident information 1303 is information about accidents that have occurred in the past. The accident information 1303 holds a record including “date,” “occurrence time,” “station name,” “route name,” “accident type,” “recovery time,” and “recovery-engaged personnel count.” The accident information 1303 has one record for one accident.

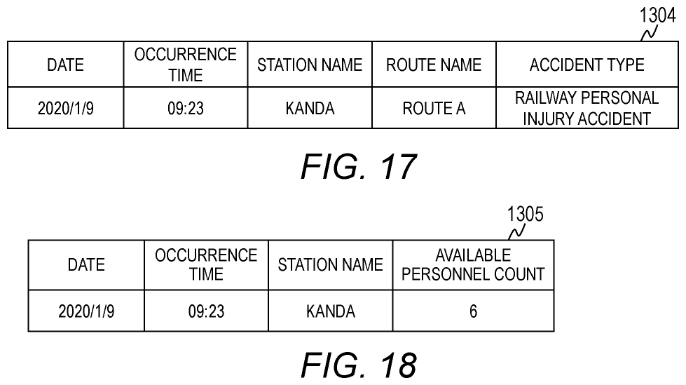

FIG. 17 is a table for showing an example of the accident data 1304 in the third embodiment.

The accident data 1304 is data about an accident that is an object of the recovery work contents data 1305 to be input. The accident data 1304 includes “date,” “occurrence time,” “station name,” “route name,” and “accident type.”

After recovery work is executed, a record is registered in the accident information 1303 based on the accident data 1304.

FIG. 18 is a table for showing an example of the recovery work contents data 1305 in the third embodiment.

The recovery work contents data 1305 is information about specific contents of recovery work accompanying the occurrence of an accident. The recovery work contents data 1305 includes “date,” “occurrence time,” “station name,” and “available personnel count.”

After recovery work is executed, a record is registered in the accident information 1303 based on the recovery work contents data 1305.

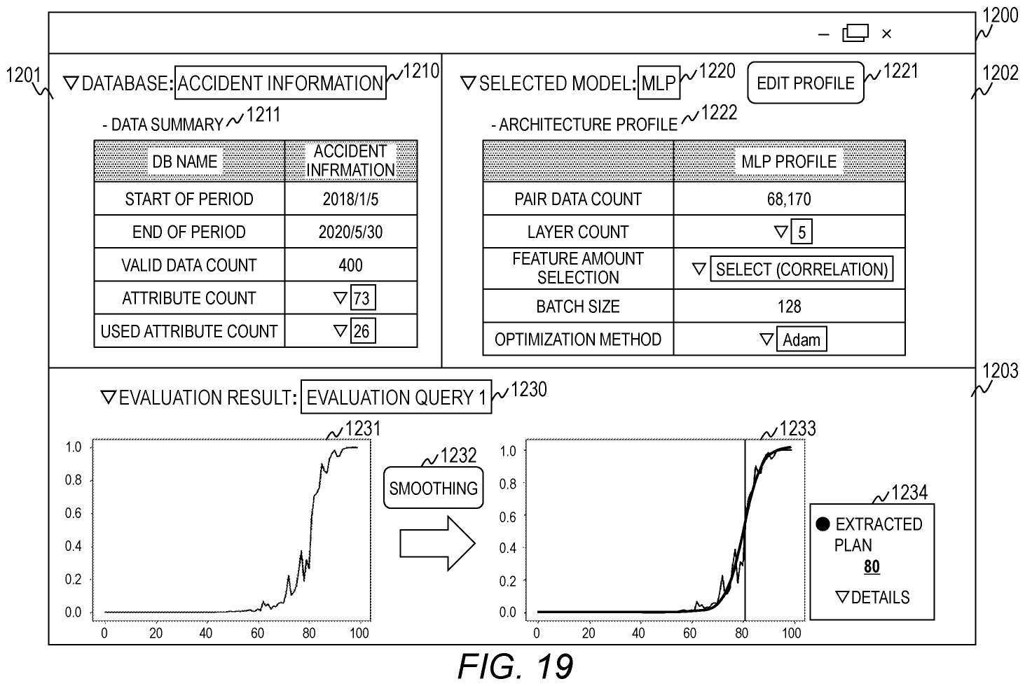

FIG. 19 is a diagram for illustrating an example of the screen 1200 to be displayed on the terminal 103 in the third embodiment.

The screen 1200 is a screen displayed based on the plan evaluation information 220, and includes the data setting field 1201, the learning setting field 1202, and the evaluation result field 1203. The fields may be displayed as separate screens.

As illustrated in FIG. 19, in the third embodiment, records of the accident information 1303 are treated as history data. In this case, the plan evaluation module 130 extracts attributes of the accident data 1304 from the plan data in the data conversion processing of Step S404. In Step S405, the plan evaluation module 130 generates pair data with the use of the attributes of the accident data 1304 and attributes of the history data.

The evaluation result display field 1234 displays the sort number of the similar history data. In a case where “details” in the evaluation result display field 1234 is selected, a record of the accident information 1303 that corresponds to the sort number is presented. A record of the train operation record information 1301 and a record of the route/station information 1302 that are associated with the record of the accident information 1303 may be presented.

The computer system according to the third embodiment can select and present the similar history data based on the plan data. The user can evaluate whether a recovery plan is good and determine contents of correction and the like based on the similar history data. For example, the user can correct the number of workers to be distributed and the like by referring to a record of the accident data 1303 that is selected as the similar history data.

### Fourth Embodiment

In the fourth embodiment, a computer system for outputting a predicted reconstruction cost from a plan for post-disaster reconstruction is described.

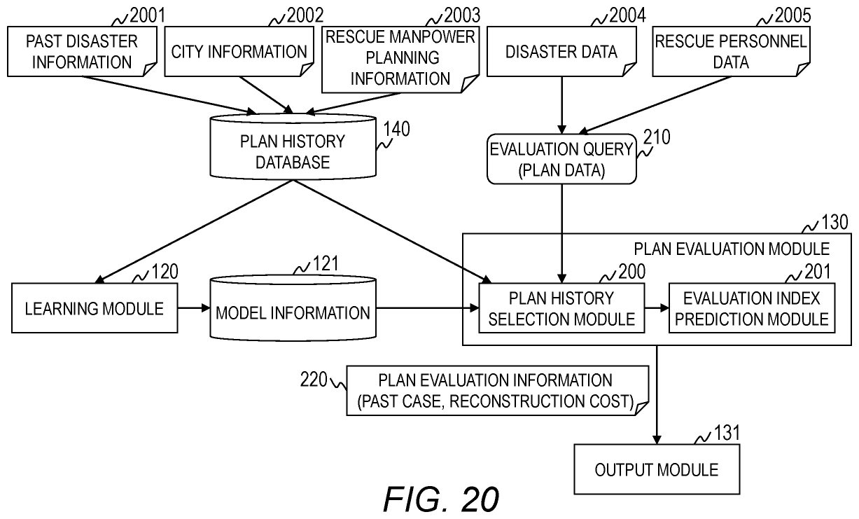

A configuration of the computer system according to the fourth embodiment is the same as the computer system configuration in the first embodiment, and a description thereof is therefore omitted. FIG. 20 is a diagram for illustrating an image of operation of the computer system according to the fourth embodiment.

The plan history database 140 stores past disaster information 2001, city information 2002, and rescue manpower planning information 2003, which are obtained from a system run by a national government, a local government, or the like.

The terminal 103 transmits the evaluation query 210 including plan data that includes disaster data 2004 and rescue personnel data 2005 to the plan evaluation module 130.

The plan evaluation module 130 generates the plan evaluation information 220 including the similar history data (a past case), and including a reconstruction cost, and outputs the plan evaluation information 220 to the output module 131.

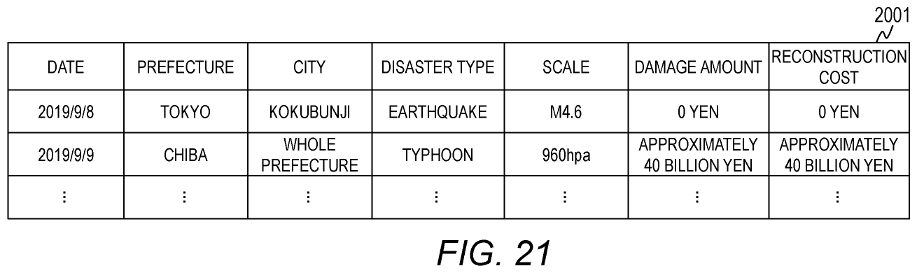

FIG. 21 is a table for showing an example of the past disaster information 2001 in the fourth embodiment.

The past disaster information 2001 is information about disasters that have occurred in the past. The past disaster information 2001 holds a record including “date,” “prefecture,” “city,” “disaster type,” “scale,” “damage amount,” and “reconstruction cost.” The past disaster information 2001 has one record for one disaster.

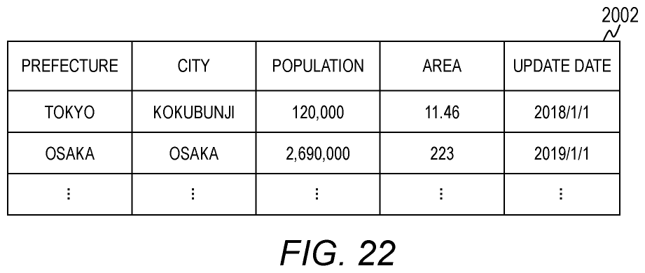

FIG. 22 is a table for showing an example of the city information 2002 in the fourth embodiment.

The city information 2002 is information about cities. The city information 2002 holds a record including “prefecture,” “city,” “population,” “area,” and “update date.” The city information 2002 has one record for one combination of “prefecture” and “city.”

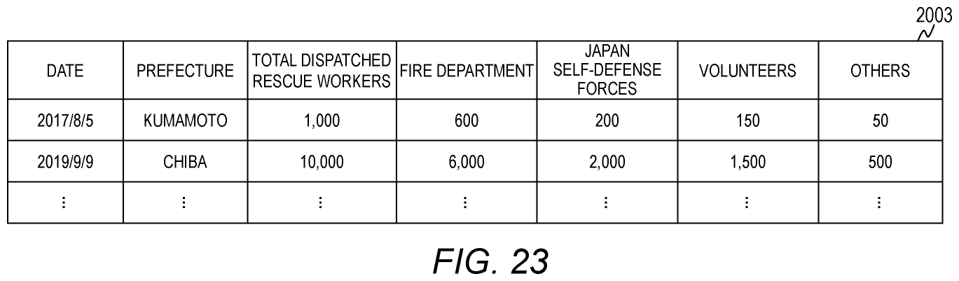

FIG. 23 is a table for showing an example of the rescue manpower planning information 2003 in the fourth embodiment.

The rescue manpower planning information 2003 is information for managing a plan for assigning personnel to rescue work in a disaster-affected area. The rescue manpower planning information 2003 holds a record including “date,” “prefecture,” “total dispatched rescue workers,” “fire department,” “Japan Self-Defense Forces,” “volunteers,” and “others.” The rescue manpower planning information 2003 has one record for one plan.

“Fire department” is a field for storing the number of fire department workers. “Japan Self-Defense Forces” is a field for storing the number of Japan Self-Defense Forces members. “Volunteers” is a field for storing the number of volunteers. “Others” is a field for storing the number of workers from a local government and the like.

A record of the rescue manpower planning information 2003 is managed in association with a record of the past disaster information 2001 that has the same combination of “date” and “prefecture” as the one in the record to be managed.

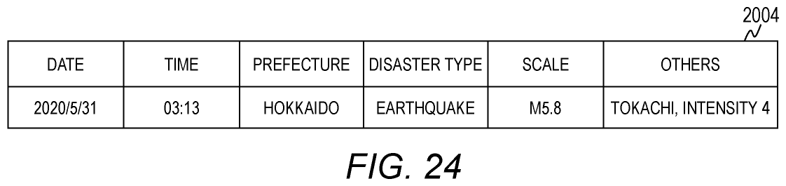

FIG. 24 is a table for showing an example of the disaster data 2004 in the fourth embodiment.

The disaster data 2004 is data about a disaster to which rescue personnel are dispatched. The disaster data 2004 includes “date,” “time,” “prefecture,” “disaster type,” “scale,” and “others.”

“Others” is a field for storing a city and other types of auxiliary information of the disaster.

After rescue work is executed, a record is registered in the past disaster information 2001 based on the disaster data 2004.

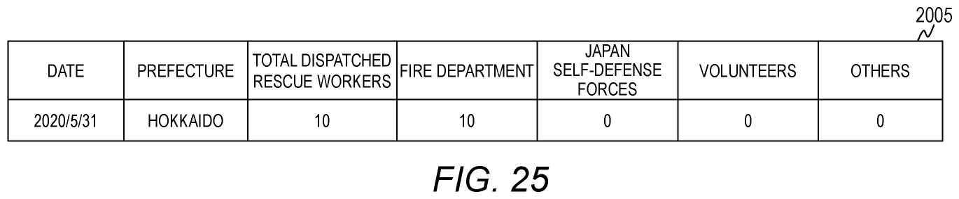

FIG. 25 is a table for showing an example of the rescue personnel data 2005 in the fourth embodiment.

The rescue personnel data 2005 is information about specific assignment of personnel to rescue work. The rescue personnel data 2005 includes “date,” “prefecture,” “total dispatched rescue workers,” “fire department,” “Japan Self-Defense Forces,” “volunteers,” and “others.”

After rescue work is executed, a record is registered in the rescue manpower planning information 2003 based on the rescue personnel data 2005.

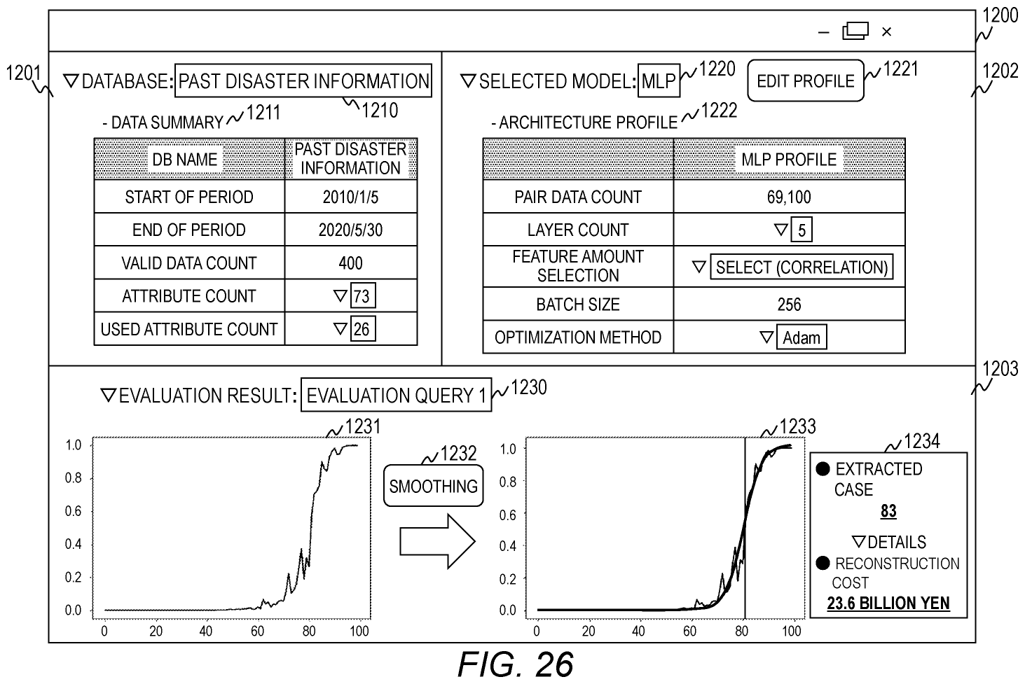

FIG. 26 is a diagram for illustrating an example of the screen 1200 to be displayed on the terminal 103 in the fourth embodiment.

The screen 1200 includes the data setting field 1201, the learning setting field 1202, and the evaluation result field 1203. The fields may be displayed as separate screens.

As illustrated in FIG. 26, in the fourth embodiment, records of the past disaster information 2001 are treated as history data. In this case, the plan evaluation module 130 extracts attributes of the disaster data 2004 from the plan data in the data conversion processing of Step S404. In Step S405, the plan evaluation module 130 generates pair data with the use of the attributes of the disaster data 2004 and attributes of the history data.

The evaluation result display field 1234 displays the sort number of the similar history data and the reconstruction cost. In a case where “details” in the evaluation result display field 1234 is selected, a record of the past disaster information 2001 that corresponds to the sort number is presented. A record of the city information 2002 and a record of the rescue manpower planning information 2003 that are associated with the record of the past disaster information 2001 may be presented.

The computer system according to the fourth embodiment can select the similar history data based on the plan data, and further present a reconstruction cost with the use of the similar history data. The user can evaluate whether a rescue personnel plan is good and determine contents of correction and the like based on the similar history data and the reconstruction cost. For example, the user can correct the number of rescue workers to be distributed and the like by referring to a record of the past disaster information 2001 that is selected as the similar history data and a record of the rescue manpower planning information 2003 that is associated with the selected record.

### Fifth Embodiment

In a fifth embodiment of this invention, a computer system receives a plurality of plans and selects a plan that is relatively highly evaluated out of the plurality of plans.

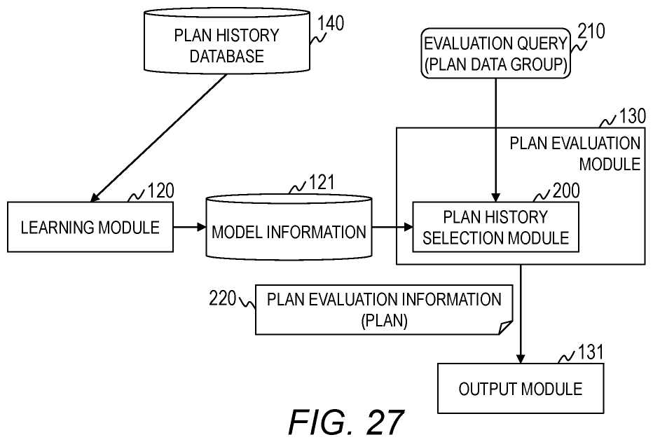

A configuration of the computer system according to the fifth embodiment is the same as the computer system configuration in the first embodiment, and a description thereof is therefore omitted. FIG. 27 is a diagram for illustrating an image of operation of the computer system according to the fifth embodiment.

The terminal 103 transmits the evaluation query 210 including a plurality of pieces of plan data to the plan evaluation module 130. One piece of plan data includes attribute values related to one plan.

The plan evaluation module 130 generates plan pair data from the plurality of pieces of plan data, and calculates probabilities by inputting the pair data to a model. The plan evaluation module 130 uses the plurality of probabilities to execute relative evaluation of the plans, and selects recommended plan data based on a result of the evaluation. The plan evaluation module 130 generates the plan evaluation information 220 including the recommended plan data, and outputs the plan evaluation information 220 to the output module 131.

Processing executed by the learning module 120 in the fifth embodiment is the same as the one in the first embodiment, and a description thereof is therefore omitted.

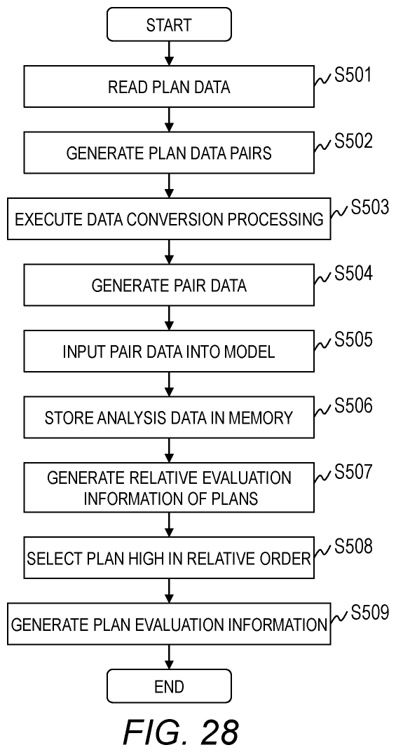

The fifth embodiment differs from the first embodiment in the processing executed by the plan evaluation module 130. FIG. 28 is a flow chart for illustrating the processing executed by the plan evaluation module 130 in the fifth embodiment.

The plan evaluation module 130 starts processing described below in a case of receiving the evaluation query 210.

The plan evaluation module 130 reads pieces of plan data included in the evaluation query 210 (Step S501), and generates a plurality of plan data pairs (Step S502).

The plan evaluation module 130 next executes data conversion processing for the plan data pairs (Step S503).

The plan evaluation module 130 next generates pair data for each of the plan data pairs by coupling two pieces of plan data for which the data conversion processing has been executed (Step S504).

Next, the plan history selection module 200 of the plan evaluation module 130 inputs the pair data to a model defined by the model information 121 (Step S505). The model outputs a probability of an evaluation index of one of the two pieces of plan data being smaller than an evaluation index of another of the two pieces of plan data.

The evaluation indices of the pieces of plan data are unknown, but a relative magnitude relationship between the pieces of plan data can be estimated with the use of the model.

The plan history selection module 200 of the plan evaluation module 130 next generates, for one piece of pair data, analysis data including identification information of two pieces of history data and the probability, and stores the analysis data in the memory 111 (Step S506).

The plan history selection module 200 of the plan evaluation module 130 next uses a plurality of pieces of analysis data to generate relative evaluation information of plans (Step S507).

Specifically, the plan history selection module 200 determines a relative order of plans based on a plurality of analysis data, and generates relative evaluation information indicating the relative order of the plans.

The plan history selection module 200 of the plan evaluation module 130 next selects a plan placed high in the relative order, based on the relative evaluation information (Step S508).

Next, the plan evaluation module 130 generates the plan evaluation information 220 (Step S509), and then ends the processing.

Specifically, the plan evaluation module 130 generates the plan evaluation information 220 including the selected plan data. The plan evaluation module 130 stores the plan evaluation information 220 in the memory 111 in association with the identification information of the evaluation query 210.

The plan evaluation module 130 may execute the processing illustrated in FIG. 6 after Step S508 is finished, with the selected plan data as input. This enables the computer system to select similar history data of the selected plan and calculate a predicted evaluation index.

According to the fifth embodiment, the computer system can select a plan high in relative evaluation out of a plurality of plans even when evaluation indices are unknown. The user can execute verification and analysis of a developed plan by referring to the selected plan.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system, comprising at least one computer including an arithmetic apparatus, a storage apparatus, and a coupling interface,
the computer system being coupled to a first database and a second database, the first database storing model information defining a model which receives, as input, pair data that is a combination of two pieces of plan data each indicating a plan developed in order to achieve a predetermined goal, and which outputs a prediction result indicating a magnitude relationship between evaluation indices of the two plans, the second database storing history data indicating a plan developed in a past,
the history data including a value of an attribute related to the plan,
the at least one computer being configured to:
generate, in a case where an evaluation query including evaluation plan data that indicates an evaluation target plan has been received, a plurality of pieces of the pair data each of which is a pair of the evaluation plan data and the history data;
obtain a plurality of prediction results by inputting the plurality of pieces of the pair data to the model;
select a piece of the history data that has an evaluation index small in difference from the evaluation index of the evaluation target plan based on the plurality of prediction results; and
output plan evaluation information including the selected piece of the history data.

2. The computer system according to claim 1,
wherein a piece of the history data is associated with the evaluation index of the plan corresponding to the piece of the history data, and
wherein the at least one computer is configured to:
calculate a predicted evaluation index of the evaluation target plan based on the evaluation index associated with the selected piece of the history data; and
output the plan evaluation information including the predicted evaluation index.

3. The computer system according to claim 2, wherein the at least one computer is configured to:
generate learning pair data that is a combination of two pieces of the history data;
assign a label that is one of 0 and 1 based on a magnitude relationship between the evaluation indices associated with the two pieces of the history data that form the learning pair data; and
generate the model information by executing learning processing in which a plurality of pieces of learning data each including the learning pair data and the label are used.

4. The computer system according to claim 3, wherein the at least one computer is configured to output, before start of the learning processing, display information for displaying a screen on which a type of the model is received.

5. The computer system according to claim 2,
wherein the prediction result is a probability indicating a possibility of the evaluation index of one of the two pieces of plan data that form the pair data being larger than the evaluation index of another of the two pieces of plan data, and
wherein the at least one computer is configured to select a piece of the history data that forms the pair data and that is the smallest in terms of error between the probability and 0.5.

6. The computer system according to claim 2, wherein the at least one computer is configured to:
sort the plurality of prediction results based on the evaluation index of the piece of the history data that forms the pair data; and
output the plan evaluation information including display information for displaying a result of the sorting and the selected piece of the history data.

7. A plan evaluation method to be executed by a computer system,
the computer system including at least one computer having an arithmetic apparatus, a storage apparatus, and a coupling interface,
the computer system being coupled to a first database and a second database, the first database storing model information defining a model which receives, as input, pair data that is a combination of two pieces of plan data each indicating a plan developed in order to achieve a predetermined goal, and which outputs a prediction result indicating a magnitude relationship between evaluation indices of the two plans, the second database storing history data indicating a plan developed in a past,
the history data including a value of an attribute related to the plan, and being managed in association with the evaluation index,
the plan evaluation method including:
a first step of generating, by the at least one computer, in a case where an evaluation query including evaluation plan data that indicates an evaluation target plan has been received, a plurality of pieces of the pair data each of which is a pair of the evaluation plan data and the history data;
a second step of obtaining, by the at least one computer, a plurality of prediction results by inputting the plurality of pieces of the pair data to the model;
a third step of selecting, by the at least one computer, a piece of the history data that has an evaluation index small in difference from the evaluation index of the evaluation target plan based on the plurality of prediction results; and
a fourth step of outputting, by the at least one computer, plan evaluation information including the selected piece of the history data.

8. The plan evaluation method according to claim 7,
wherein the third step includes calculating, by the at least one computer, a predicted evaluation index of the evaluation target plan based on the evaluation index of the selected piece of the history data, and
wherein the fourth step includes outputting, by the at least one computer, the plan evaluation information including the predicted evaluation index.

9. The plan evaluation method according to claim 8, further including:
generating, by the at least one computer, learning pair data that is a combination of two pieces of the history data;
assigning, by the at least one computer, a label that is one of 0 and 1, based on a magnitude relationship between the evaluation indices of the two pieces of the history data that form the learning pair data; and
generating, by the at least one computer, the model information by executing learning processing in which a plurality of pieces of learning data each including the learning pair data and the label are used.

10. The plan evaluation method according to claim 9, further including outputting, by the at least one computer, display information for displaying a screen on which a type of the model is received, before start of the learning processing.

11. The plan evaluation method according to claim 8,
wherein the prediction result is a probability indicating a possibility of the evaluation index of one of the two pieces of plan data that form the pair data being larger than the evaluation index of another of the two pieces of plan data, and
wherein the third step includes selecting, by the at least one computer, a piece of the history data that forms the pair data and that is the smallest in terms of error between the probability and 0.5.

12. The plan evaluation method according to claim 8,
wherein the third step includes sorting, by the at least one computer, the plurality of prediction results based on the evaluation index of the piece of the history data that forms the pair data, and
wherein the fourth step includes outputting, by the at least one computer, the plan evaluation information including display information for displaying a result of the sorting and the selected piece of the history data.

13. A computer system, comprising at least one computer including an arithmetic apparatus, a storage apparatus, and a coupling interface,
the computer system holding model information defining a model which receives, as input, pair data that is a combination of two pieces of plan data each indicating a plan developed in order to achieve a predetermined goal, and which outputs a prediction result indicating a magnitude relationship between evaluation indices of the two plans,
the at least one computer being configured to:
generate, in a case where an evaluation query including a plurality of pieces of plan data each indicating a plan has been received, a plurality of pieces of the pair data each of which is a pair of two pieces of plan data out of the plurality of pieces of plan data;
obtain a plurality of prediction results by inputting the plurality of pieces of the pair data to the model;
select one of the plurality of pieces of plan data that corresponds to a plan high in relative evaluation based on the plurality of prediction results; and
output the selected one of the plurality of pieces of plan data.
